(19) United States
(12) Patent Application Publication
(10) Pub. No.: US 2012/0096281 A1
(43) Pub. Date: Apr. 19, 2012

(54) SELECTIVE STORAGE ENCRYPTION

(76) Inventors: Mathew S. ESZENYI, Hillsboro, OR (US); Michael P. MESNIER, Scappoose, OR (US)

(21) Appl. No.: 13/336,411

(22) Filed: Dec. 23, 2011

Related U.S. Application Data
(63) Continuation-in-part of application No. 12/319,012, filed on Dec. 31, 2008.

(51) Int. Cl. G06F 12/14

(52) U.S. Cl. 713/189

(57) ABSTRACT

A storage device includes encryption policies that may be applied to data stored thereon. Different encryption policies may be applied to different data on the storage device. Input/output (I/O) requests may identify the appropriate encryption policy to be applied using a data tag of the I/O request. The data tag may be applied by the file system when the I/O request is issued, or may be added by a filter driver before the I/O request is delivered to the storage device.

### RELATED APPLICATION DATA

This application is a continuation-in-part of co-pending U.S. patent application Ser. No. 12/319,012, filed Dec. 31, 2008, which is herein incorporated by reference.

### TECHNICAL FIELD

This invention pertains to storage systems, and more particularly to applying different encryption policies to different data on storage system.

### BACKGROUND

There has long been a recognized need to protect data on storage devices. Disk drive manufacturers have attempted to meet this need by building devices that have encryption built into the device. And operating system manufacturers have similarly attempted to meet this need by building encryption into their operating systems.

But neither solution adequately solves the problem. Disk drive encryption is a slow process, taking potentially four times as long to read or write a block of data as unencrypted access would take. In addition, disk drive encryption does not factor in the logical structure of the data on the disk drive. While this delay might be acceptable if every block of data on the disk drive required encryption, it is an expensive price to pay with respect to data that does not require encryption.

Encryption by the operating system may take advantage of the logical structure of the data on the disk, and may be selective as to what files are encrypted. But the operating system operates at a higher level than the disk drive. File system encryption, therefore, operates above the block level. As a result, file system structure may still be visible on the disk, resulting in weaker security.

A need remains for a way to address these and other problems associated with the prior art.

### BRIEF DESCRIPTION OF THE DRAWINGS

Embodiments of the present invention are illustrated by way of example, and not by way of limitation, in the drawings and in which like reference numerals refer to similar elements.

FIG. 1 shows a computer system with a storage device that may support selective encryption, according to an embodiment of the invention.

FIG. 2 shows details of the storage device of FIG. 1.

FIG. 3 shows data flow within the storage device of FIG. 1.

FIG. 4 shows details of the encryption policies in the memory of the storage device of FIG. 1.

FIG. 5 shows a flowchart of a procedure for adding a data tag to an input/output (I/O) request, according to an embodiment of the invention.

FIGS. 6A-6B show a flowchart of a procedure for applying selective encryption on the storage device of FIG. 1, according to an embodiment of the invention.

### DETAILED DESCRIPTION

Co-pending U.S. patent application Ser. No. 12/319,012, filed Dec. 31, 2008, which is herein incorporated by reference, describes a storage device that includes support for improving quality of service. “Quality of service” is a broad concept, which can encompass many different “services”. One such “service” is encryption of data on the storage device; this concept is explored further below.

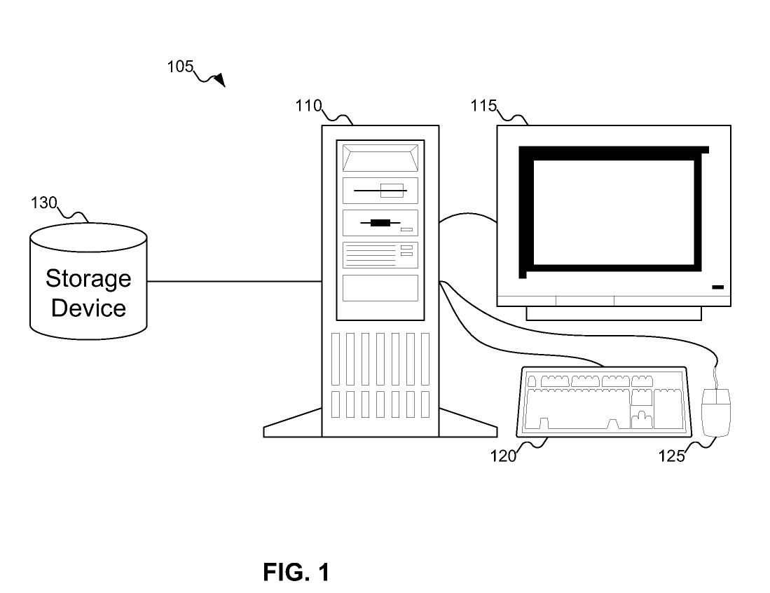

FIG. 1 shows a computer system with a storage device that may support selective encryption, according to an embodiment of the invention. In FIG. 1, computer system 105 is shown as including computer 110, monitor 115, keyboard 120, and mouse 125. A person skilled in the art will recognize that other components may be included with computer system 105: for example, other input/output devices, such as a printer. In addition, FIG. 1 computer system 105 may include conventional internal components not shown in FIG. 1: for example, a central processing unit, memory, etc. Although not shown in FIG. 1, a person skilled in the art will recognize that computer system 105 may interact with other computer systems, either directly or over a network (not shown) of any type. Finally, although FIG. 1 shows computer system 105 as a conventional desktop computer, a person skilled in the art will recognize that computer system 105 may be any type of machine or computing device capable of providing the services attributed herein to computer system 105, including, for example, a laptop computer, a personal digital assistant (PDA), or a cellular telephone.

Computer system 105 includes storage device 130. Storage device 130 may be any device that may store data. Storage device 130 may be a hard drive, storage area network (SAN), or other forms. In addition, storage device 130 may utilize magnetic storage, optical storage, or solid state storage, among other possibilities. Storage device 130 may be volatile or non-volatile memory.

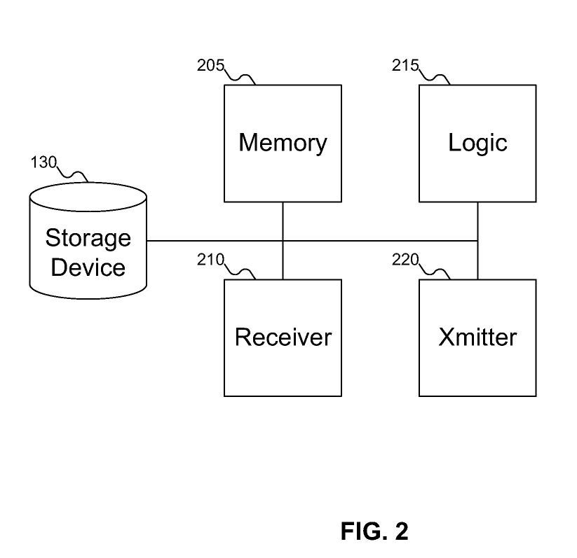

FIG. 2 shows details of the storage device of FIG. 1. In FIG. 2, storage device 130 includes memory 205, receiver 210, logic 215, and transmitter 220. Memory 205 may store information about encryption algorithms that may be used to selectively encrypt data on storage device 130. Receiver 210 may receive input/output (I/O) requests from a file system, database, or any user application on the computer. Logic 215 may use the information about the encryption algorithms to selectively encrypt data on storage device 130. Transmitter 220 may transmit the result of the I/O request back to the file system on the computer.

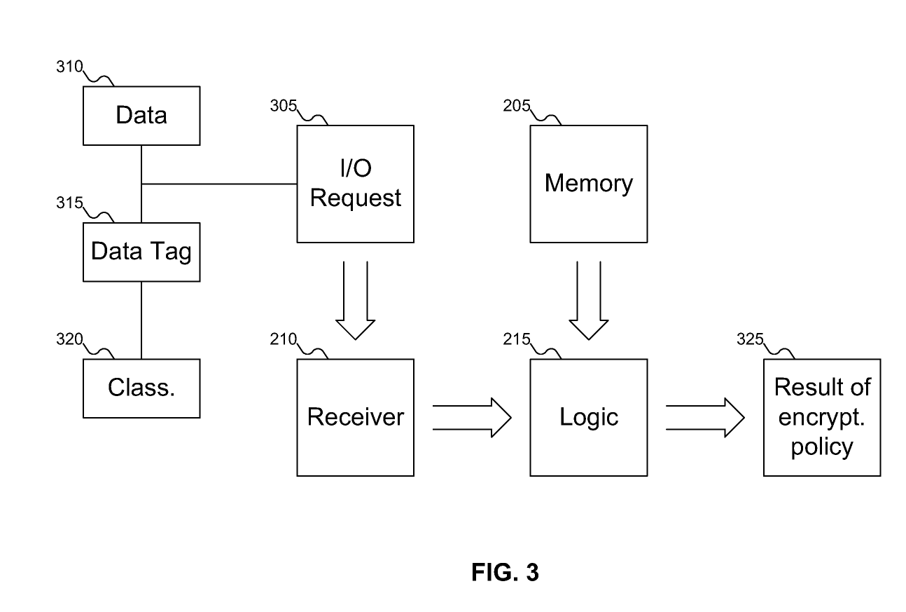

FIG. 3 shows data flow within the storage device of FIG. 1. In FIG. 3, I/O request 305 received by the storage device includes both an identifier of data 310 to be processed and data tag 315. The identifier of data 310 to be processed indicates what block or blocks of data on the storage device are to be read or written, depending on the specific I/O request being made of the storage device. Data tag 315 is an additional piece of data that helps the storage device know how data 310 is to be encrypted.

In one embodiment of the invention, data tag 315 includes classification 320. Classification 320 classifies data 310, giving the storage device some additional information about the data to be processed. For example, classification 320 may indicate that data 310 is an operating system file, an application, or user data, among other possibilities. Classification 320 may also indicate a type of the file: for example, is the file an executable, a library file (e.g., a dynamic link library (DLL) file), a configuration file, an XML file, and so on. Classification 320 may also be used to store some other metadata about data 310. In this manner, the storage device gains some insight into the logical structure of the data stored on the storage device. For example, if data 310 is an operating system file, this file is less critical (and more easily replaced) than user data. Thus, a lower level of encryption (or no encryption at all) may be applied to an operating system file as compared to user data, which is more sensitive.

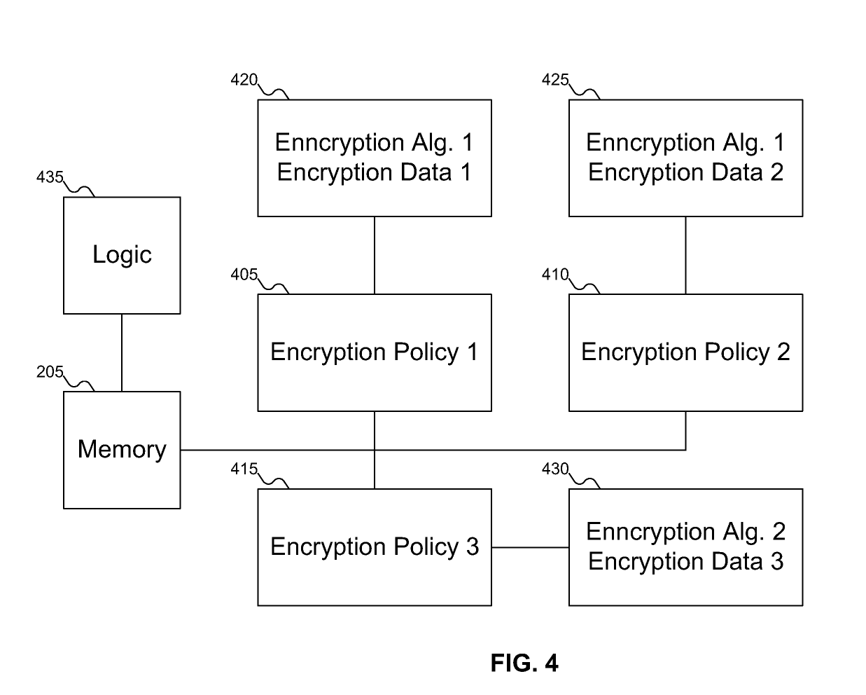

A typical data tag contains one byte, or eight bits of data, so as to minimize the amount of additional data that is sent with the I/O request. Using data tag 315 to store classification 320 allows for different data to be classified similarly, and therefore for similar encryption algorithms to be applied to various different data. Classification 320 may then be used by the storage device to access an applicable encryption policy, as described below with reference to FIG. 4. This arrangement makes it easy to modify how encryption is to be applied to various classifications: a change to a single policy modifies how encryption is performed with respect to all data associated with that policy. One byte is also typically insufficient space to directly store information about a particular encryption algorithm to apply to data 310. But a person of ordinary skill in the art will recognize that data tag 315 may be of any length. This also means that data tag 315 may also be used to directly store encryption information, rather than using the indirect approach of classification 320.

Once I/O request 305 is received by receiver 210, logic 215 uses memory 205 to determine the encryption algorithm to be applied to data 310. As discussed below with reference to FIG. 4, memory 205 stores the encryption policies to be applied to data 310. The result of applying the encryption policy is result 325.

The encryption algorithm applied can be any encryption algorithm. For example, the Data Encryption Standard (DES), American National Standards Institute (ANSI) X3.92-1981 (R1998), approved Feb. 5, 1999, and the Advanced Encryption Standard (AES), Federal Information Processing Standards (FIPS) 197, published Nov. 26, 2011, are both examples of encryption algorithms that can be used, although a person of ordinary skill in the art will recognize that any other encryption algorithm can be used.

Note that when the encryption algorithm is applied may depend on the type of I/O request 305. If I/O request 305 is a read request, then the encryption algorithm is applied after the data is read from the storage device. If I/O request 305 is a write request, then the encryption algorithm is applied before the data is written to the storage device. But either way, the encryption algorithm is applied during processing of I/O request 305, within the storage device.

FIG. 4 shows details of the encryption policies in the memory of the storage device of FIG. 1. In FIG. 4, memory 205 is shown. Memory 205 includes various encryption policies: in FIG. 4, three encryption policies 405, 410, and 415 are shown. But a person of ordinary skill in the art will recognize that there may be any number of encryption policies. For example, data tag is used to directly identify an encryption policy to use, then the data tag may identify up to 2⁸=256 different encryption policies. (Of course, if the data tag is used to classify the data, and the classification is then used to select the encryption policy, there can be any number of encryption policies, even theoretically more encryption policies that can be directly identified given the size of the data tag. For example, while there might only be 256 classifications possible using a one byte data tag, these 256 classifications can select from among any number of encryption policies.)

Each encryption policy has associated metadata that specifies operational parameters of the encryption algorithm. For example, encryption policy 405 has encryption metadata 420, encryption policy 410 has encryption metadata 425, and encryption policy 415 has encryption metadata 430. The encryption metadata may be any data appropriate to the encryption algorithm. For example, the encryption metadata may include the key to be used to encrypt the data.

Note that, in general, each pair of encryption policies will differ in some way. That is, for any pair of encryption policies, the two policies will use different encryption algorithms, different encryption metadata or both. Thus, for example, encryption metadata 420 and 425 differ as to the metadata, but use the same encryption algorithm; encryption metadata 420 and 430 differ as to both the encryption algorithm and metadata. But a person of ordinary skill in the art will recognize that there is no reason why “different” encryption policies might not have identical encryption metadata.

Also shown in FIG. 4 is logic 435. Logic 435 maps a given classification to a particular encryption policy. That is, given a particular classification, logic 435 is responsible for identifying the appropriate encryption policy to use with respect to the data. But, as discussed above with reference to FIG. 3, if the data tag directly identifies the encryption policy to be used, then logic 435 may be omitted.

In one embodiment of the invention, the mapping from classification to encryption policy, the various encryption policies 405, 410, and 415 themselves, and the associate data 420, 425, and 430 for each encryption policy 405, 410, 415 are pre-programmed into the storage device. That is, logic 435, encryption policies 405, 410, and 415, and encryption metadata 420, 425, and 430 may all be programmed into the storage device at the time of manufacture. In another embodiment of the invention, logic 435, encryption policies 405, 410, and 415, and encryption metadata 420, 425, and 430 may be programmed by the end user after installing the storage device. A person of ordinary skill in the art will also recognize that these embodiments of the invention may be combined: that is, the storage device may be pre-programmed at the time of manufacture, but the end user may change the programming to meet their specific needs. Thus, different embodiments of the invention may utilize any desired memory structure to store mapping logic 435, encryption policies 405, 410, 415, and encryption metadata 420, 425, and 430. Such memory structures may include any variety of Read Only Memory (ROM), any variety of Random Access Memory (RAM), any variety of magnetic or optical storage, or any other desired memory structure.

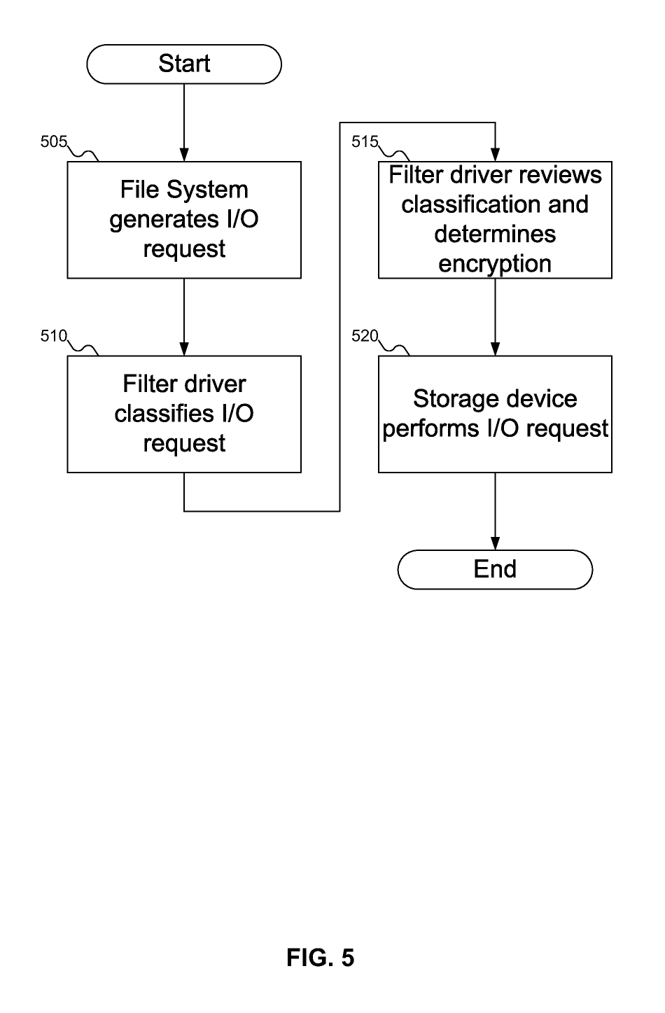

FIG. 5 shows a flowchart of a procedure for adding a data tag to an input/output (I/O) request, according to an embodiment of the invention. In FIG. 5, at block 505 a file system generates an I/O request. This may include the block of data to be read or written. In some embodiments, the file system generates the I/O request without specifying the data tag; in other embodiments, the file system may be smart enough to include the data tag.

Assuming the data tag is not included, then at block 510 a filter driver classifies the I/O request, determining what data is to be processed. At block 515, a filter driver reviews the classification and determines the appropriate encryption policy to be applied to the data. Once the appropriate encryption policy is determined, the appropriate classification may be specified in the data tag (or the encryption policy is specified directly in the data tag). The I/O request, as modified by the filter driver, may then be forwarded to the storage device for processing, as in block 520.

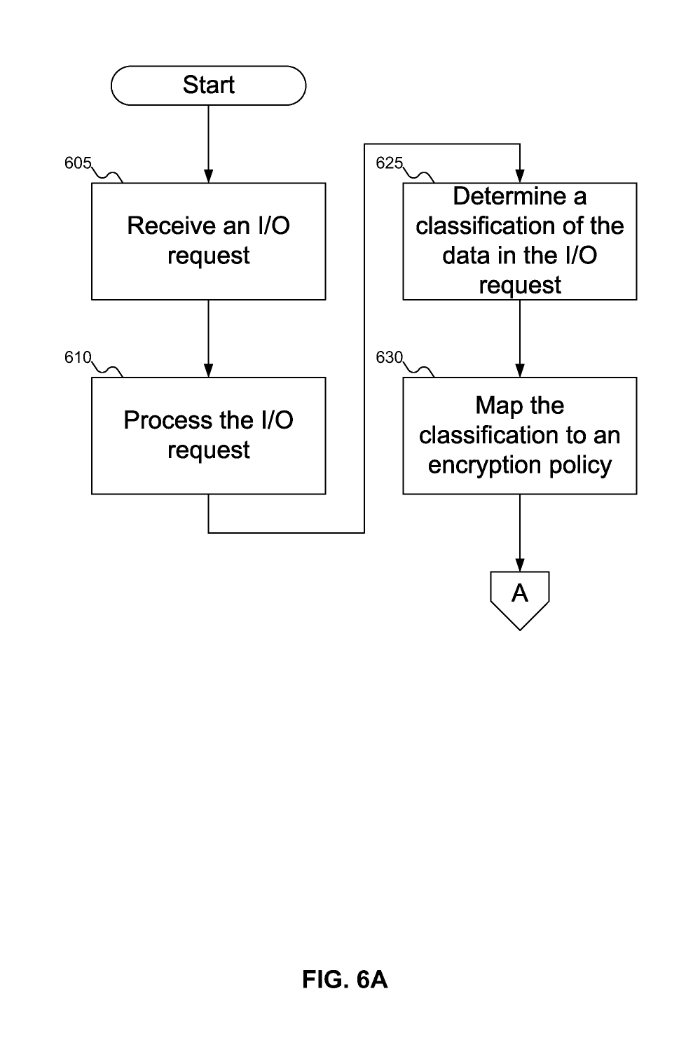

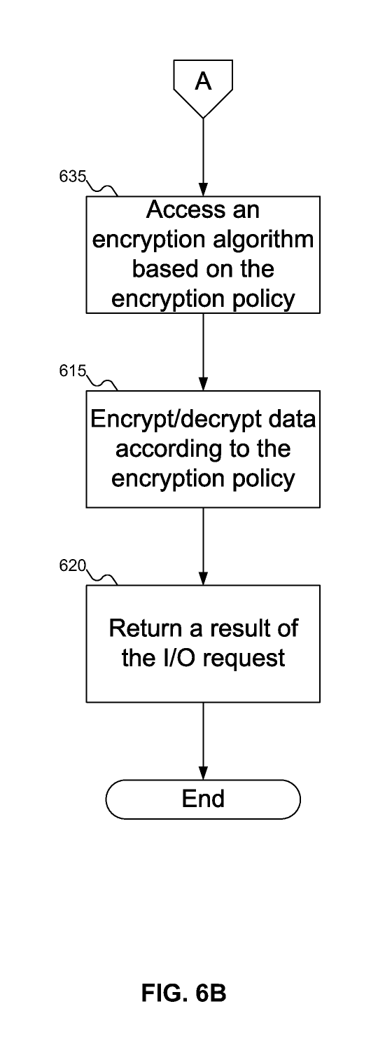

FIGS. 6A-6B show a flowchart of a procedure for applying selective encryption on the storage device of FIG. 1, according to an embodiment of the invention. In FIG. 6A at block 605, the storage device receives an I/O request. At block 610, the storage device processes the I/O request. At block 615, the storage device determines a classification of the I/O request from a data tag in the I/O request. At block 620, the storage device maps the classification in the data tag to an encryption policy. As discussed above, the data tag may directly specify the encryption policy: in such an embodiment of the invention, the classification does not need to be mapped to an encryption policy.

At block 625 (FIG. 6B), the storage device accesses an encryption algorithm based on the encryption policy. At block 630, the storage device encrypts and/or decrypts the data using the encryption algorithm, as appropriate to the I/O request. At block 635, the storage device returns a result of the I/O request.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciated that network communication may utilize various wired and/or wireless short range or long range carriers and protocols, including radio frequency (RF), satellite, microwave, any of the Institute of Electrical and Electronics Engineers (IEEE) 810.11 standards, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc.: such associated data, by virtue of being stored on a storage medium, does not include propagated signals. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And, though the foregoing discussion has focused on particular embodiments, other configurations are contemplated. In particular, even though expressions such as “in one embodiment” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A storage system, comprising:
a storage device;
a memory to store at least a first encryption algorithm and a second encryption algorithm, said first encryption algorithm different from said second encryption algorithm;
a receiver to receive an input/output request, said I/O request identifying data on the storage device and including a data tag, said data tag relating to a first encryption algorithm to apply to the data;
logic to apply said first encryption algorithm as part of processing said I/O request; and
a transmitter to return a result of said I/O request.

2. A storage system according to claim 1, wherein
the receiver is operative to receive said I/O request, said I/O request identifying said data on the storage device and including said data tag, said data tag specifying a classification of said data; and
the storage system further comprises logic to map said classification of said data to an encryption policy, said encryption policy being one of at least two encryption policies, said encryption policy specifying said first encryption algorithm.

3. A storage system according to claim 2, wherein:
the I/O request is a read request;
the logic to apply said first encryption algorithm includes logic to apply said first encryption algorithm to decrypt said data after reading said data from the storage device; and
the transmitter is operative to transmit said decrypted data.

4. A storage system according to claim 2, wherein:
the I/O request is a write request;
the logic to apply said first encryption algorithm includes logic to apply said first encryption algorithm to said data before said data is written to the storage device; and
the transmitter is operative to transmit a result of said write request.

5. A storage system according to claim 2, wherein said classification of said data is associated with a type of said data.

6. A storage system according to claim 2, wherein the receiver is operative to receive said I/O request a filter driver, said filter driver operative to receive said I/O request identifying said data from a file system and said filter driver operative to add said data tag to said I/O request before forwarding said I/O request to the storage system.

7. A storage system according to claim 1, wherein the first encryption algorithm is an Advanced Encryption Standard algorithm.

8. A method, comprising:
receiving an input/output request at a storage device, the I/O request identifying a first data and including a data tag relating to a first encryption algorithm to apply to the first data;
processing the I/O request, including applying the first encryption algorithm to the first data; and
returning a result of processing the I/O request,
wherein the storage device includes the first encryption algorithm and a second encryption algorithm applicable to a second data on the storage device.

9. A method according to claim 8, wherein:
receiving an I/O request includes receiving the I/O request identifying the first data and including the data tag, the data tag specifying a classification of the first data; and
processing the I/O request includes mapping the classification of the first data to a first encryption policy that specifies the first encryption algorithm,
wherein the storage device includes a first plurality of classifications that may be mapped to a second plurality of encryption policies, each of the second plurality of encryption policies specifying an encryption algorithm.

10. A method according to claim 9, wherein:
receiving an I/O request includes receiving a read request for the first data;
processing the I/O request further includes:
accessing an encrypted data from the storage device; and
decrypting the encrypted data to produce the first data; and
returning a result includes returning the first data.

11. A method according to claim 9, wherein:
receiving an I/O request includes receiving a write request for the first data;
processing the I/O request further includes:
encrypting the first data to produce an encrypted data; and
writing the encrypted data to the storage device.

12. A method according to claim 9, wherein receiving an I/O request further includes receiving the I/O request identifying the first data and including the data tag, the data tag specifying a classification of the first data, the classification of the first data associated with a type of the first data.

13. A method according to claim 9, wherein receiving an I/O request further includes receiving the I/O request identifying the first data and including the data tag from a filter driver, the filter driver receiving the I/O request identifying the first data from a file system and the filter driver adding the data tag to the I/O request before forwarding the I/O request to the storage device.

14. A method according to claim 8, wherein applying the first encryption algorithm to the first data includes applying an Advanced Encryption Standard algorithm to the first data.

15. An article, comprising a non-transitory storage medium, said non-transitory storage medium having stored thereon instructions that, when executed by a machine, result in:
receiving an input/output request at a storage device, the I/O request identifying a first data and including a data tag relating to a first encryption algorithm to apply to the first data;
processing the I/O request, including applying the first encryption algorithm to the first data; and
returning a result of processing the I/O request,
wherein the storage device also includes a second data encrypted using a second encryption algorithm.

16. An article according to claim 15, wherein:
receiving an I/O request includes receiving the I/O request identifying the first data and including the data tag, the data tag specifying a classification of the first data; and
processing the I/O request includes mapping the classification of the first data to a first encryption policy that specifies the first encryption algorithm,
wherein the storage device includes a first plurality of classifications that may be mapped to a second plurality of encryption policies, each of the second plurality of encryption policies specifying an encryption algorithm.

17. An article according to claim 16, wherein:
receiving an I/O request includes receiving a read request for the first data;
processing the I/O request further includes:
accessing an encrypted data from the storage device; and
decrypting the encrypted data to produce the first data; and
returning a result includes returning the first data.

18. An article according to claim 16, wherein:
receiving an I/O request includes receiving a write request for the first data;
processing the I/O request further includes:
encrypting the first data to produce an encrypted data; and
writing the encrypted data to the storage device.

19. An article according to claim 16, wherein receiving an I/O request further includes receiving the I/O request identifying the first data and including the data tag, the data tag specifying a classification of the first data, the classification of the first data associated with a type of the first data.

20. An article according to claim 16, wherein receiving an I/O request further includes receiving the I/O request identifying the first data and including the data tag from a filter driver, the filter driver receiving the I/O request identifying the first data from a file system and the filter driver adding the data tag to the I/O request before forwarding the I/O request to the storage device.

21. An article according to claim 15, wherein applying the first encryption algorithm to the first data includes applying an Advanced Encryption Standard algorithm to the first data.
